(19) United States
(12) Patent Application Publication
(10) Pub. No.: US 2008/0259209 A1
(43) Pub. Date: Oct. 23, 2008

(54) SYSTEM AND METHOD FOR CONVERGING AND DISPLAYING HIGH DEFINITION VIDEO SIGNALS

(76) Inventors: Greg Houlgate, Carlsbad, CA (US); William Harvey, Chicago, IL (US)

Correspondence Address: CAHN & SAMUELS LLP, 1100 17th STREET NW, SUITE 401, WASHINGTON, DC, 20036, US

(21) Appl. No.: 12/102,774

(22) Filed: Apr. 14, 2008

Related U.S. Application Data
(60) Provisional application No. 60/911,501, filed on Apr. 12, 2007.

(51) Int. Cl. H04N 7/015; H04N 7/16; H04N 7/10

(52) U.S. Cl. 348/461; 725/139; 725/34; 348/E07.004

(57) ABSTRACT

A system and method for processing and displaying a unitary image formed from the combination of a broadcast signal with a second signal with no or minimal modification, alteration or degradation of the broadcast signal. In one embodiment, the system and method processes and displays a High Definition Television (HDTV) video signal with another High Definition (HD) video and/or non-video digital media signal as one combined HD image. This convergence allows the HDTV video signal and the additional HD signal to be displayed on a monitor as a combined HD image without any modification in the appearance of the HDTV image when compared to an unprocessed HDTV image. The system and method allows an HDTV video signal to be wrapped and displayed with an additional media, such as advertising and entertainment, in a variety of display configurations. The advertising and entertainment may be selected based on various considerations to provide targeted advertising and entertainment.

### I. CROSS REFERENCE TO RELATED APPLICATION

This application claims the benefit of U.S. Provisional Patent Application No. 60/911,501, filed Apr. 12, 2007, which is incorporated herein by reference.

### II. FIELD OF THE INVENTION

This invention relates generally to a system and method for processing and displaying a broadcast signal with a second signal with minimal or no modification, alteration or degradation of the broadcast signal. More specifically, the present invention in at least one embodiment provides a system and method for processing and displaying a High Definition Television (HDTV) video signal with another High Definition (HD) video and/or non-video digital media signal as one combined HD media signal.

### III. BACKGROUND OF THE INVENTION

High Definition Television (HDTV) is a format for the broadcast of digital television. HDTV has a much higher resolution than traditional broadcast formats such as the National Television Standards (NTSC) used in the United States and at least twice the linear resolution of standard definition television (SDTV). HDTV is typically broadcast in digital as digital broadcast requires much less bandwidth. HDTV offers several advantages over analog television and SDTV, such as the ability to show more detail, overall better picture quality, a higher resolution that maintains picture quality on larger screens, the ability to multicast-broadcast several signals over the same bandwidth, and the ability to handle 16:9 aspect ratio without using anamorphic stretch or letterboxing.

Over the last several years, there has been tremendous growth in the popularity of HDTV. With this growth there has also been many new HDTV standards developed. These standards define the High Definition (HD) signal and are set by the International Telecommunication Union (ITU) as 1080 active interlace or progressive scan lines, or 720 progressive scan lines, in a 16:9 aspect ratio. The broadcast formats are defined by the number of lines of vertical display resolution, whether progressive scan or interlaced fields are used, and the number of frames per second. Progressive frames draw every line while interlace fields draw every other line in one scan and the other lines in the next scan.

There are many different HDTV standards, combining signals of different standards and media types is not easily performed. Computer systems can be used to emulate a digital television (DTV) standard. However, these systems cannot readily combine High Definition media sources and types. As such, the full utility of HDTV has not been achieved, in part due to the difficulty in combining High Definition standards and media types.

Further to this point, display monitors contain a limited amount of space in which content may be displayed. Many entities interested in displaying additional content, such as advertisements, informational notices, etc., with a broadcast desire to attain the most display space for this additional content while maintaining the quality and integrity of the broadcast image. However, displaying additional content with an image being broadcasted has typically interrupted, i.e., obstructed or covered, the image being broadcasted. In these applications, the additional content signals are generally layered over the image to form a broadcast signal which results in at least a portion, and often large amounts, of the image being interrupted by the layered additional content when broadcasted.

There are several layering techniques used to display additional content that supplements the main image being broadcasted. Some of the more commonly used layering techniques include bordering, paneling, inserting, and offsetting. Bordering and paneling is the practice of displaying additional content over and along the perimeter of an image. This is done because the perimeter of the image is often regarded as the least important part of the image. Border and panel layering techniques substantially interrupt the image by covering the perimeter of the image. Inserting involves placing additional an within the field of the image. This technique also covers a portion of the image. Offsetting is a more specialized and involved technique that, unlike most broadcast display techniques, displays the image in an off-set or off-centered fashion. Offsetting of the image allows the additional content to be displayed in a larger display area with less obstruction of the image than would be possible without offsetting the image. These broadcast techniques often require that various considerations and adjustments be made to display additional content with the image to form the broadcast. This is particularly true in the case of offset which also requires that many special considerations and adjustments be made during production of the image, such as deliberately filming in an unconventional manner to ensure that the image is displayed in a particular fashion, i.e., a certain area of the monitor.

While these broadcast techniques provide a means for displaying additional content along with the primary image in a broadcast signal, they also interfere with the primary image. It is most often appropriate to limit the use of these techniques to the display of “specialty” images having matched additional content.

Producers of broadcast programming are typically adverse to their broadcast image being altered. Also, alteration of a broadcast image may have unintended legal consequences. Under copyright laws, the alteration of a copyrighted work may lead to legal disputes. This generally results in broadcasters avoiding the alteration of broadcast signals and the contained images. As such, producers generally provide their own additional content within their broadcast signal, if additional content is provided at all. This also prevents the simultaneous display of the image and additional content having unmatched or incompatible formats, such as overlapping broadcast and content signals. For example, displaying a regular (non-offset) broadcast image with an additional content intended for display with an offset image would likely cause great obstruction of the non-offset image. The flexibility and potential created by providing increased additional content space for simultaneous and contiguous display with the image without interrupting the broadcast signal has not been accomplished. Similarly, there has not been accomplished a means for displaying an uninterrupted broadcast image with an additional content without respect to the display format of the image and additional content.

U.S. Pat. No. 6,892,226 to Tso et al. discloses a system for the delivery of dynamic content to a client device that delivers targeted on-line advertising to the client device. The system responds to a users request for a web page by automatically presenting an advertisement to the user in addition to the web page. The system utilizes information provided by a dynamic executable module running on the client device to embed the advertisements into the webpage prior to download.

Similarly, U.S. Pat. No. 7,039,599 to Merriman et al. discloses a method and apparatus for automatic placement of advertising in scarce media via an internet advertising network. The system attempts to correlate particular advertisements with particular media space in an effort to optimize the media space. The system selects advertisements to be embedded in media by criteria generated from a predictive model and statistical analysis of the user's response to previous advertisements.

U.S. Pat. No. 7,117,516 to Khoo et al. discloses a method and system for providing a customized media list to a user over a data network. The method provides personalized data of the user to a computer system, generates a customized media list based on the personal data, and provides the customized media list to the user through the computer system. The customized media list represents customized content and customized advertising.

### IV. SUMMARY OF THE INVENTION

The invention contemplates a system and method for processing and displaying a broadcast signal with a second signal with no or minimal modification, alteration or degradation of the broadcast signal.

This invention in at least one embodiment provides a method of processing a broadcast digital television signal, including receiving a broadcast digital video signal including television content; obtaining at least one other digital signal including digital content; combining the broadcast digital video signal with the at least one other digital signal to form a combined digital media signal including a unitary image that maintains the integrity of the television content of the broadcast digital video signal and the entire digital content is unobstructed by the television content; and outputting the combined digital media signal.

This invention in at least one embodiment provides a method of converging a High Definition Television (HDTV) signal, including receiving a first main High Definition video signal including television content; receiving at least a second main High Definition video signal including primary digital content; obtaining at least one auxiliary High Definition signal including auxiliary digital content; combining the first main High Definition video signal with the at least one auxiliary High Definition signal to form a first combined High Definition signal including a first unitary image having television content contiguous to auxiliary content; combining the second main High Definition video signal with the at least one auxiliary signal to form a second combined High Definition including a second unitary image having primary digital content contiguous to auxiliary content; and outputting the first combined High Definition signal and the second combined High Definition signal.

This invention in at least one embodiment provides a computer program product comprising a computer useable medium including a computer readable program, wherein the computer readable program when executed on a computer causes the computer to receive a broadcast video signal, wherein the signal includes television content; obtain at least one other digital signal, wherein the signal includes digital content; and combine the broadcast digital video signal and the at least one other digital signal into one combined digital media signal including a unitary image that maintains the integrity of the broadcast digital video signal.

This invention in at least one embodiment provides a data processing system including means for combining a High Definition broadcast digital video signal including television content with an auxiliary High Definition digital signal including digital content to form a unitary image wherein the television content is contiguous to the digital content; and at least one display connected to the means for combining that displays the unitary image.

This invention in at least one embodiment provides a method for scheduling and displaying media on an advertising network, including receiving a list of advertisement files into a content catalog wherein the list contains at least one advertisement file; approving the advertisement files to be included in a database of advertisement files, wherein approving the advertisements files includes accepting the advertisement file parameters to ensure compliance with system guidelines, reviewing the content of the advertisement file to ensure compliance with appropriateness standards, and placing a rules tag on the advertisement file that regulates how the file is to be displayed; authorizing the advertisement file for publication; publishing the advertisement file to the advertising network; assigning a display schedule to the advertisement file; and displaying the advertisement file consistent with the display schedule and rules tags.

An objective of the invention in at least one embodiment is to provide a system and method for combining an HDTV video signal with one or more High Definition video signals resulting in a single High Definition video signal that is a convergence of both signals with minimal modification, alteration or degradation of the broadcast signal. The converged HD signal is displayed on one or more HD monitors as one contiguous signal containing both television and non-television content. The television/broadcast content and non-television/non-broadcast content can be displayed in a variety of display configurations.

An advantage of the invention in at least one embodiment is that new aspects of the utility and capability of digital media, in general and HDTV video in particular, are realized. The invention in at least one embodiment allows for readily combining HD media content without regard to standards or media type. The invention in at least one embodiment provides a network for displaying targeted advertisements and entertainment with a television broadcast wherein the advertisements and entertainment are selected to have a relationship to the show or event being broadcast, the display location, or numerous other factors and considerations.

### V. BRIEF DESCRIPTION OF THE DRAWINGS

The present invention is described with reference to the accompanying drawings, wherein:

FIG. 1A illustrates a system in accordance with an exemplary embodiment of the present invention.

FIG. 1B illustrates a method in accordance with an exemplary embodiment of the present invention.

FIGS. 2A-2G illustrate display zones and layouts in accordance with exemplary embodiments of the present invention.

FIG. 3 illustrates a method of a software convergence of signals in accordance with an exemplary embodiment of the present invention.

FIG. 4 illustrates an alternative method of a software convergence of High Definition signals in accordance with an exemplary embodiment of the present invention.

FIG. 5 illustrates a method of a hardware convergence of High Definition signals in accordance with an exemplary embodiment of the present invention.

FIG. 6 illustrates an alternative method of a hardware convergence of High Definition signals in accordance with an exemplary embodiment of the present invention.

FIG. 7 illustrates another alternative method of a hardware convergence of High Definition signals in accordance with an exemplary embodiment of the present invention.

FIG. 8 illustrates a system for scheduling and displaying media on an advertising network in accordance with an exemplary embodiment of the present invention.

Given the following enabling description of the drawings, the system and method of the present invention should become evident to a person of ordinary skill in the art.

### VI. DETAILED DESCRIPTION OF THE DRAWINGS

The present invention describes a system and method for combining and displaying a digital broadcast video signal with another digital video signal.

The system and method of the present invention in at least one embodiment is directed to combining High Definition (HD) signals. The combined signal may include many types of HD media content, including for example broadcast television, over-the-air (OTA) HDTV, pre-recorded video, streaming video, live video, computer graphics, games, etc. That content may represent advertisements, entertainment, information, or other video applications. The HDTV signal and another HD signal are processed and combined in a manner that produces one combined HD image to be outputted in one HD signal. Also in at least one embodiment, the video component of the first HDTV video signal is processed such that there is no perceivable delay of the video component. However, in the event that the processing creates a perceivable delay of the video component, the audio component is delayed to be synchronized with the video component. This convergence enables coherent use of the combined HD media. As such, the coordinated signal provides for both customized selective content and display arrangement. For example, the signal may include targeted advertisements that are matched to a selected broadcast wherein the broadcast and advertisement are both independently and simultaneously displayed in a user-defined arrangement permitting the content to be selectively locatable in the combined image to be displayed.

In accordance with an aspect of the invention, the system of the present invention in at least one embodiment combines a television/broadcast content signal and an additional content/non-broadcast signal into a unitary and outputs the combined content as one signal to a display. The system combines High Definition (HD) content signals with other HD content signals but is also capable of combining an HD broadcast signal with a content signal from a non-HD source. In accordance with another aspect of the invention, the system in at least one embodiment combines non-HD content signals with other non-HD or HD signals to form a unitary image.

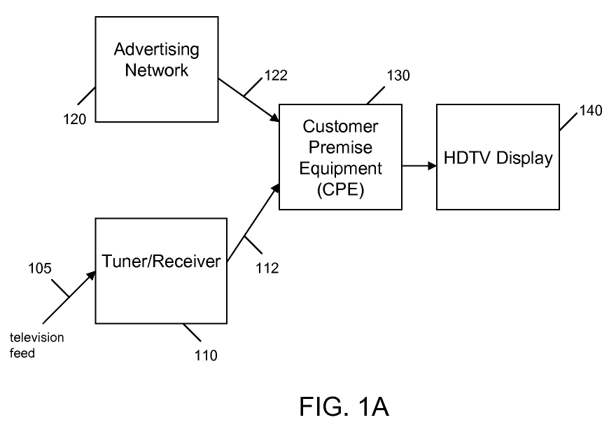

FIG. 1A outlines an exemplary system of the present invention. The system includes an Advertising Network 120 that is preferably an application specific content distribution network that operates on standard computer platforms and Internet protocols, e.g., TCP/IP over a WAN or LAN. The Advertising Network 120 executes a content display program to output a signal 122 to Customer Premise Equipment (CPE) 130. A television feed 105 is received by a tuner or receiver 110 that outputs a signal 112 to the CPE 130. CPE 130 executes a TV display program that combines signals 112, 122 into a unitary image and outputs one combined signal 132 to at least one display (or projection system) 140. The signals 112 and 122 may be HD or non-HD signals and are combined as a unitary image to be output as one combined signal to an HD or non-HD display 140.

The CPE 130 includes an Advertising Network Display Interface (ANDI) or Display Interface to combine the signals into a unitary image for display on at least one HDTV. The Display Interface in at least one embodiment is a computer, e.g. a PC, which processes the signals. An example of the specifications for the Display Interface include a Pentium 4 CPU, 512 MB RAM, Windows XP operating system, an HDTV tuner having a cable input, and an internet connection, preferably Ethernet. The Advertising Network 120 may utilize a WAN for connection to the Internet and a LAN for a multi-display connection to the Display Interface. The television feed provides content to the CPE 130, for example, over a coaxial cable. In a managed channel environment, the CPE 130 allows for channel selection in a specific market, such as local cable and local broadcast television. In an unmanaged channel environment, the CPE 130 accepts television content on a predefined channel. Channel selection is made from the network provider's equipment to the designated television channel. This typically occurs in the case of satellite television providers, such as DirecTV and Dish Network, and with in-house video mixing. While any size HDTV display may be used with the present invention, displays of 42 inches and larger are preferred. Also, the HDTV display in at least one embodiment supports Full High Definition (FHD) at 1920×1080 pixels computer resolution.

FIG. 1B outlines an exemplary method of the present invention. At 115, a broadcast digital television video signal is received by the CPE 130 from tuner/receiver 110. At 125, another digital content signal is received by the CPE 130 from the Advertising Network 120. At 135, the received broadcast television video signal and the other digital content signal are converged by the CPE 130 into a unitary image with minimal or no modification, alteration or degradation of the broadcast signal. At 145, the combined video signal is output for display on one or more monitors.

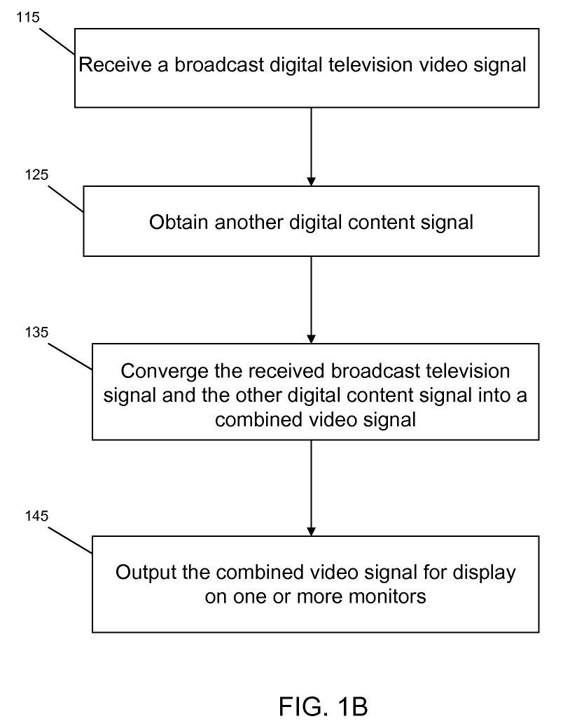

The convergence of television and additional content signals allows the combined signals to be output to one or more HD displays in a variety of layout configurations. In addition to a full screen display, the present invention allows advertising and entertainment content (that in at least one embodiment is HD) to wrap an HDTV, DTV or standard TV signal. FIGS. 2A-G illustrate the display zones and a variety of display layouts that may be practiced with the present invention wherein the various display zones are distinguished by shading for illustration. FIG. 2A illustrates a display 200 having a variety of display zones 1-5. Display zone 1 is a TV zone that typically displays broadcast or recorded television. Display zones 2-5 are HD zones that wrap TV zone 1 with HD content, including video, graphics and text. HD display zone 2 is a bottom banner display zone. HD display zone 3 is a corner display zone. HD display zone 4 is an extender zone that is used as part of a full wrap zone or to extend the display zone of an adjacent zone. HD display zone 5 is a top right vertical display. In given applications one or more of display zones 2-5 may include HD content. These zones may be combined to provide additional layout arrangements with examples shown in FIGS. 2B-2G.

FIG. 2B illustrates a display layout that includes a TV zone 1 this is wrapped by content in individual zones 2-5. FIG. 2C illustrates a display layout that includes a TV zone 1 wrapped by a bottom banner display zone 2, corner display zone 3, and an extended side display zone comprised of zones 4 and 5. FIG. 2D illustrates a display layout that includes a TV zone 1 wrapped by a ¾ display zone and a right top vertical display zone 5. The ¾ display zone is comprised of a bottom banner display zone 2, a corner display zone 3, and an extender zone 4. FIG. 2E illustrates a display layout that includes a TV zone 1 wrapped by a bottom banner display zone 2, an extended corner display zone, and a side banner display zone 5. The extended corner display zone is comprised of zones 3 and 4. FIG. 2F illustrates a display layout that includes a TV zone 1 wrapped by a bottom banner display zone 2, and extended side banner including zones 3-5. FIG. 2G illustrates a display layout that includes a TV zone 1 wrapped by a bottom banner display zone 2, a corner display zone 3, an extender display zone 4, and a top right vertical display 5. These layouts are listed as examples of configurations that may be practiced with at least one embodiment of the present invention. The term “wrap” is not intended to be limited to a particular geometric configuration but is intended to indicate the contiguous abutment between the unmodified broadcast zone, i.e. the TV zone, and the additional content display zones.

Each of the display zones 2-5, illustrated in FIG. 2A, may be set to display the same or different targeted content. In one instance, the display zones 2-5 may be set to display targeted content that matches or is related to content displayed in the TV zone 1, for example, drink and food specials during a football game or trivia during a network show. In another instance, the display zones 2-5 may also be set to display targeted content that matches or is related to the facility. In both instances, this content may be any combination of advertisements, entertainment, such as trivia or games, and/or related media and may be related to, for example, the programming or entertainment displayed in TV zone 1 by a variety of standards and setting, e.g., predefined demographics, time of day, season, decency, and the like.

While the present invention and various embodiment examples are described with respect to display zones placed along the bottom and right sides of the monitor, it is noted that this is mainly for convenience and explanation purposes. The present invention is not intended to be limited to the depicted display zone locations. As such, the orientation of the content is selectable by either the end user or the system provider. In most applications the arrangement of the display will be controlled by the system provider. The display zones may be placed anywhere within the monitor and in various combinations without departing from the invention so long as the placement does not interfere or significantly affect the display of the image being broadcasted, i.e. the placement of the display zones does not lead to the alteration, modification or degradation of the video component of the broadcast signal. In at least one embodiment, the broadcast signal image predominates the image that is displayed.

Convergence of Signals

While the illustrated embodiments of the present invention including the various signal convergence systems and methods are described with respect to HD signals, it should be understood that HD signals are preferred by but are not required by the systems and methods and that other signal types can be used. The present invention in at least one embodiment is capable of performing the described signal convergences on any combination of HD and non-HD signals.

In keeping with the invention, CPE 130 preferably converges or combines a broadcast HDTV video signal 112 with another HD video signal 122. This convergence of signals may be accomplished in two general manners, including software convergence and hardware convergence. Software convergence is accomplished by utilizing software applications to manipulate the video in such a way that the output emulates a typical digital television (DTV) output. Hardware convergence is accomplished by utilizing separate video processing hardware or equipment external to the Display Interface to combine the HD signals. Both software convergence and hardware convergence combine the HDTV video signal and another HD video signal such that the combined image can be outputted as one combined HD media signal to one or more HD monitors without any significant alteration in the appearance of the video component of the broadcast signal, e.g. maintaining the integrity and the entirety of the video component and the at least one other HD video signal image is displayed in its entirety. Maintaining the integrity and entirety of the video component means that the combined HD media signal includes minimal or no modification, alteration or degradation of the video component of the broadcast signal including maintaining the video component in the received aspect ratio. The broadcast signal video component of the combined HD media signal is substantially identical to the received broadcast television video component and no portions of the displayed broadcast television video component are obstructed, covered, layered, cropped, lost or otherwise interrupted. In at least one embodiment, the at least one other HD video signal is a non-broadcast signal.

The convergence of signals is controlled by software such as the TV display program described below. In the software embodiments, the program is resident on a display interface that processes the signals. In the hardware convergence embodiments, the program is resident on a video mixer that processes the signals. The software and hardware convergence of signals is discussed further below. In all embodiments, the TV display program is responsible for the capture, manipulation and output for display of TV video, either broadcast or stored. The TV display program causes the system to receive either an HD or non-HD TV input or signal via an HD compatible video capture component, such as a video card.

In software convergence embodiments, the video capture component also stores additional HD content, either video or non-video. This additional HD content is combined with the TV signal and transformed into a compressed video format, such as MPEG-2. The system then, utilizing specifications that define the video environment or capabilities of the facility where the signal will be displayed, selects the most appropriate settings to yield the highest quality video at that facility. These settings may be stored on the system or input by a user and include, for example, type of video, such as HDMI, S-video, composite video, RG6, and the like, as well as the display resolution, for example 480, 720p, 1080i, and 1080p. Utilizing these settings the system regulates the output signal display controls thereby determining how the combined output signal is displayed, i.e., pan, stretch, zoom, and so forth.

Hardware convergence embodiments are preferably utilized in more demanding HD environments as these embodiments produce higher quality video outputs. In hardware convergence embodiments, the TV display program is stored on a video mixing component. The video mixing component receives both a TV signal from a TV tuner or receiver and an additional HD content signal from a display interface. The video mixing component combines both signals in accordance with settings similar to the software convergence embodiments, as stated above. However, in the hardware convergence embodiments, the software containing the program is provided and stored on the video mixing component. In this illustrated embodiment, there is no compression of the video. Instead the video mixing component receives, combines and outputs the received signals for display to one or more monitors in accordance with the relevant specifications.

a. Software Convergence

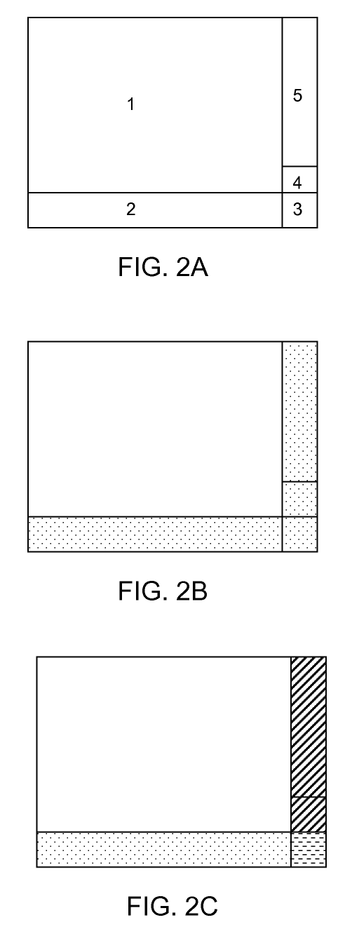

FIG. 3 illustrates an embodiment of the invention configured to provide a software convergence of an HDTV video signal and an additional HD video signal. This configuration allows one HDTV video signal to be combined with an additional HD signal that represents either video or non-video media to form a unitary image. These signals can be of any resolution whether consistent or inconsistent with HDTV. This convergence allows the HDTV video signal and an additional HD video signal to be displayed as one combined image contained in a HD video signal on an HD monitor without any significant alteration in the appearance of the HDTV video signal, e.g. maintaining the integrity and the entirety of the video component of the broadcast signal.

In performing this convergence, a HDTV tuner or receiver T₁ outputs a HDTV video signal S₁ into a Display Interface DI₁ that executes the TV display program discussed above. More particularly, the Display Interface DI₁ processes the HDTV video signal S₁ to combine an additional HD video signal S₂ that is stored on the Display Interface DI₁, as a combined HD signal C₁. This combined HD signal C₁ can then be displayed on one or more monitors M₁ such that both the HDTV video signal and the additional HD video signal are displayed together as a combined HD media. The combined HD signal C₁ allows the HDTV video signal S₁ to be displayed as TV₁ and the additional HD video signal S₂ to be displayed as AD₁. The Display Interface DI₁, includes a computer display adapter that generates the additional HD video signal S₂ component of the combined HD video signal C₁. As discussed previously, additional video signal S₂ in at least embodiment represents multiple signals providing content for different areas of AD₁ such as those described in connection with FIGS. 2A-G. Examples of computer display adapter models capable of High Definition (HD) resolutions and suitable for use with the present invention include ones using the following example chipsets: nVidia 7000 and 8000 series; ATI 1300, 1500, 2400, and 3400 series; and Intel x3000 and x3100.

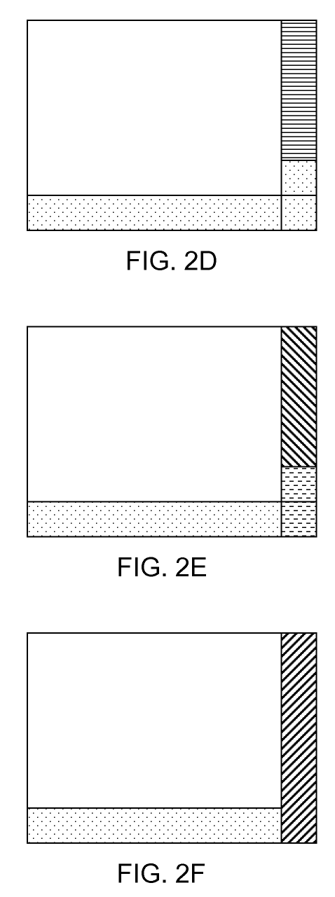

The software convergence may also be utilized to provide an alternative arrangement having multiple additional HD video signals. This arrangement allows the same HDTV video signal S₁ to be combined with different HD media to form a unitary image. In order to achieve this configuration the Display Interface DI₁, is arranged to have multiple media sources. Media sources may be provided by, for example, additional video cards on the Display Interface DI₁. FIG. 4 shows a software configuration that has a second additional media signal S₃ stored on Display Interface DI₁. The HDTV tuner T₁ outputs an HDTV video signal S₁ into Display Interface DI₁, as in the single output example above. However, in this embodiment, Display Interface DI₁, combines the HDTV video signal S₁ with two separate additional HD video signals S₂, S₃. The Display Interface DI₁, may then output two separate combined HD signals C₁, C₂ to one or more separate monitors M₁, M₂, respectively. The combined HD signals C₁, C₂ each represent a combined HD media. Similar as discussed above, the combined HD signals C₁ and C₂ allow the HDTV video signal to be displayed as TV₁ and the additional HD video signal to be displayed as AD₁ and AD₂. This arrangement allows different additional HD media, such as advertisements and entertainment (games, trivia, or information) to be displayed on different monitors having the same HD programming. The number of different combined signals that may be output utilizing this arrangement is limited by the number of video sources on or in communication with the Display Interface DI₁.

b. Hardware Convergence

The system of the present invention may also be configured to provide a hardware convergence of an HDTV video signal and an additional HD video signal. A hardware convergence is performed in a configuration that is similar to the configurations that perform a software convergence, as outlined above. However, hardware convergence arrangements utilize an Advertising Network Television Interface Equipment (ANTIE) or digital video mixer to combine the HD video signals. The digital video mixer stores the TV display program outlined above that when executed allows an HDTV video signal and an additional HD video signal to be displayed as a combined HD image on one or more monitors M₁ without any alteration in the appearance of the video component of the television signal S₁, e.g. maintaining the integrity and the entirety of the video component of the broadcast signal.

Exemplary ANTIE models suitable for use with the present invention include studio quality grade multi-image video processors such as the VCC-8000 series and Rainer 2v series that utilize a Galaxy control system preferably modified to provide the ability to scale and crop signals. The video processors and control system are available from Avitech International Corporation of Redmond, Wash. While studio quality video processors and control systems that provide the advanced features of signal scaling and cropping are preferred, other less expensive video processors may also be used. However, these other video processors typically compromise video quality. Other exemplary ANTIE models capable of use with the present invention are the MX-1003A and MX-1003B available from GoMax Electronics, Inc. of Hsinchu County, Taiwan.

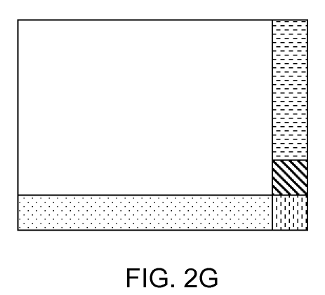

In one embodiment of a hardware convergence of HD signals, as illustrated in FIG. 5, an HDTV tuner T₁ outputs an HDTV video signal S₁ to a video mixer VM₁. Display Interface DI₁, outputs an additional HDTV video signal S₂ which is input into video mixer VM₁. Video mixer VM₁ combines both signals S₁ and S₂ and outputs a combined HD signal C₁ having a unitary image to one or more monitors M₁. This convergence allows the HDTV video signal S₁ and the additional HD video signal S₂ to be displayed as one image on one or more monitors M₁ as a combined HD media without any alteration in the appearance of the video component of the HDTV signal S₁. The combined HD signal C₁ allows the HDTV video signal to be displayed as TV₁ and the additional HD video signal to be displayed as AD₁. As discussed previously, additional video signal S₂ in at least embodiment represents multiple signals providing content for different areas of AD₁ such as those described in connection with FIGS. 2A-2G.

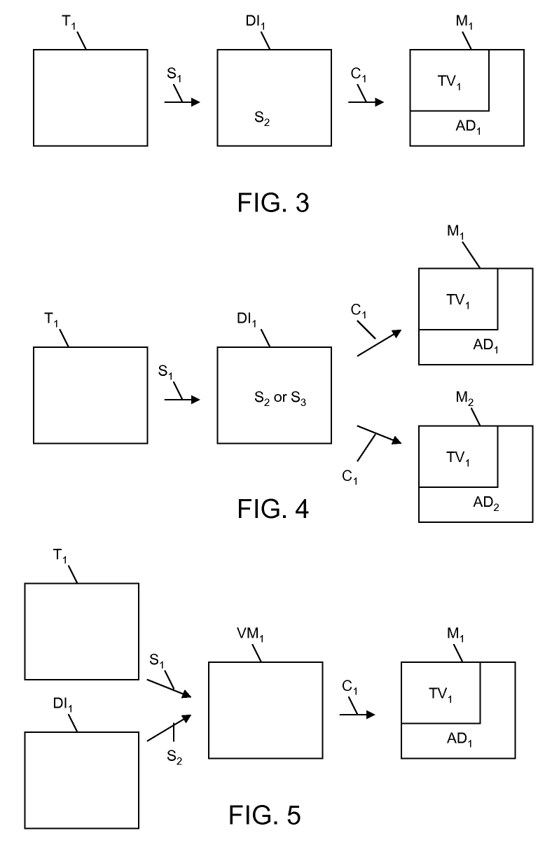

FIG. 6 shows an alternative embodiment of a hardware signal convergence of the present invention. The arrangement of this embodiment allows an HDTV video signal to be flexibly combined with multiple additional HD video signals. In this embodiment, an HDTV tuner T₁ outputs an HDTV signal S₁ to video mixer VM₁. Display Interface DI₁, outputs one or more additional HD video signals S₂ or S₃ to video mixer VM₁. Video mixer VM₁ combines the HDTV video signal S₁ with the additional HD video signal S₂ or S₃ and outputs a combined HD signal C₁ having a unitary image to one or more monitors M₁. This convergence allows the HDTV video signal S₁ and the additional HD video signal to be displayed from one combined HD signal C₁ without any alteration in the appearance of the video component of the television signal S₁. The combined HD signal C₁ allows the HDTV video signal to be displayed on one or more monitors M₁ as TV₁ and the additional HD video signal to be displayed as AD₁.

HDTV tuner T₁ also outputs an HDTV video signal S₁ to a video mixer VM₂. Display Interface DI₁, outputs one or more additional HD video signals S₂ or S₃ to video mixer VM₂. Video mixer VM₂ combines both signals S₁ and S₂ or S₁ and S₃ and outputs a combined HD signal C₂ having a unitary image. In at least one embodiment, all three signals S₁, S₂, and S₃ are combined as one image for HD signal C₂. The combined HD signal C₂ output by video mixer VM₂ is flexibly selected and dependent on the signal (S₂ or S₃) input into video mixer VM₂. This convergence allows the HDTV video signal S₁ and the additional HD video signal S₂ or S₃ to be displayed as a combined image from one HD signal C₂ on one or more monitors M₂ without any alteration in the appearance of the video component of the television signal S₁. Display Interface DI₁, may output one or more HD video signals in order to provide flexibility of combined HD media. The combined HD signal C₂ allows the HDTV video signal to be displayed on one or more monitors M₂ as TV₁ and the additional HD video signal to be displayed as AD₂. This arrangement allows one HDTV video signal to be combined with multiple additional HD media sources to from one or more unitary images that are flexibly output to multiple monitors. This arrangement may also utilize additional media sources to provide increased flexibility of combination of television and advertisements or entertainment.

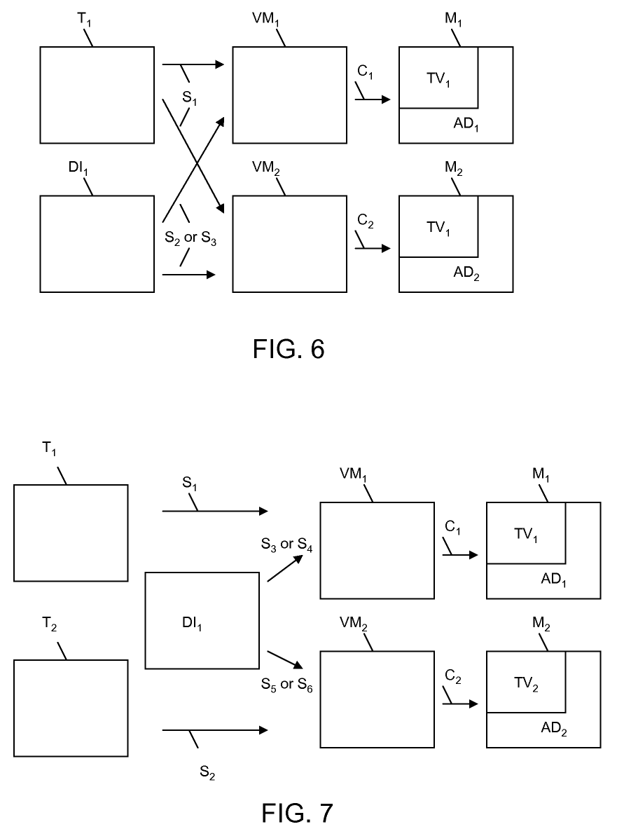

FIG. 7 provides an additional alternative embodiment of a hardware signal convergence of the present invention and utilizes multiple HDTV video signals. This arrangement provides an HDTV tuner T₁ that outputs an HDTV video signal S₁ to a video mixer VM₁. Display Interface DI₁, outputs an additional HD media signal S₃ or S₄ to video mixer VM₁. Video mixer VM₁ combines the signal S₁ with signal S₃ or S₄ and outputs a combined HD media signal C₁ having a unitary image to one or more monitors M₁. A second HDTV tuner (or other HD source) T₂ outputs an HDTV video signal S₂ to a second video mixer VM₂. Display Interface DI₁, also outputs an additional HD video signal S₅ or S₆ to video mixer VM₂. Video mixer VM₂ combines the signals S₂ with signal S₅ or S₆ and outputs a converged signal C₂ having a unitary image to one or more monitors M₂. The combined HD signal C₁ allows the HDTV video signal S₁ to be displayed on one or more monitors M₁ as TV₁ and the additional HD video signal S₃ or S₄ to be displayed as AD₁. The combined HD signal C₂ allows the HDTV video signal S₂ to be displayed on one or more monitors M₂ as TV₂ and the additional HD video signal S₅ or S₆ to be displayed as AD₂.

Also, Display Interface DI₁, may output one or more HD media signals in order to increase the flexibility of the combined HD image that is output and displayed. This arrangement allows two or more HDTV video signals to be combined with multiple additional HD media sources and flexibly output to multiple monitors. This arrangement may also utilize additional media sources to provide increased flexibility of combination of television and advertisements or entertainment.

Scheduling of Display

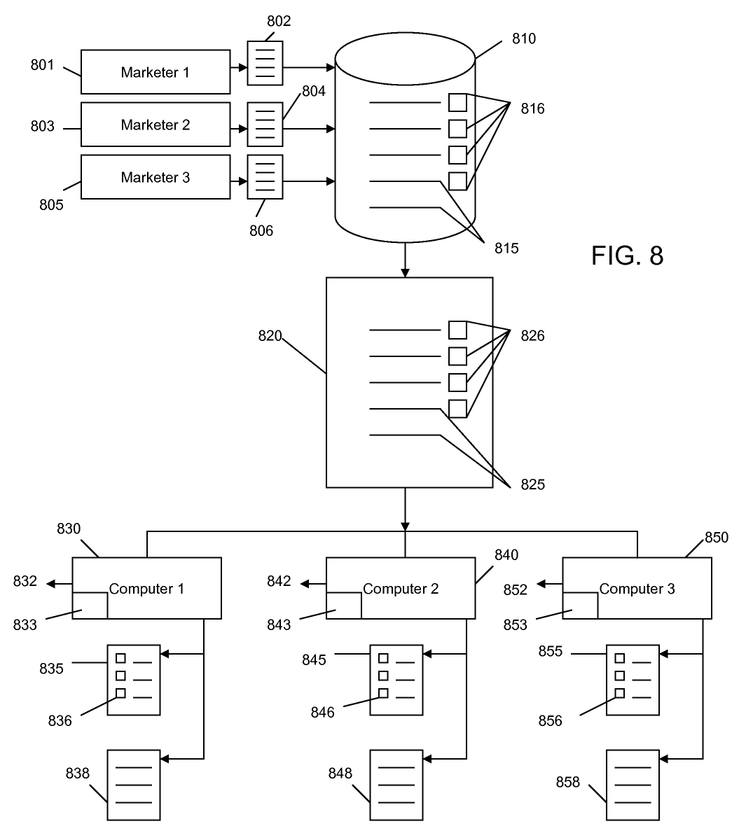

FIG. 8 illustrates a system for scheduling and displaying media on an advertising network in accordance with an exemplary embodiment of the present invention. The scheduling and display of media on the advertising network is performed by an integrated communication network. Stored on the integrated communication network is a content display program that when executed controls the content and scheduling of display based on settings and requirements. The system also has the capability to implement the content display program based on interactive communication between the ANDI or Display Interface and a web portal or remote management software. The process of scheduling media to be displayed on the network begins when marketers 801, 803, 805 supply individual media lists 802, 804, 806, that represent the marketers respective advertisements. For example, Marketer 1 produces a list 802 containing one or more advertisements that Marketer 1 would like to display on the network. Marketer 2 produces a list 804 containing one or more advertisements that Marketer 2 would like to display on the network. Similarly, Marketer 3 produces a list 806 containing one or more advertisements that Marketer 3 would like to display on the network. These lists 802, 804, 806 are submitted to the network Master Content Catalog 810 for approval to be published to the network. The Master Content Catalog 810 contains all media files whether published or unpublished.

Once the media lists 802, 804, 806 are submitted to the network Master Content Catalog 810, the system performs an approval process. The approval process includes steps of acceptance, review and authorization. The files contained on the media lists are automatically accepted in the catalog provided that the lists meet general system guidelines, such as file type, file size, file formatting, etc. Once the files are accepted they are stored on the Master Content Catalog 810 for review. The review process includes an analysis of the media files 815 to ensure that the content is appropriate for a particular market or segment. The markets may be defined by geography, location type, etc. Geographic content may be organized into, for example, national, regional, market, local, etc. The content may also be organized to meet relevant standards and conflicts (competitors), such as decency, appropriateness ratings, etc. or based on location type or segment, for example, sports arena or venue, bar, restaurant, airport/travel, etc.

The system then places a rules tag 816 on the media files 815. The rules tag 816 is associated with rules files (not shown) that regulate how the media files 815 are to be displayed. These rules files are stored in a Scheduling Catalog (not shown) on or in communication with the Master Content Catalog 810. The rules files may include, for example, begin date, end date, type of location, time of day restrictions, competitor restrictions, etc. The media files 815 are then stored in the Master Content Catalog 810 along with a separate rules tag 816 associated with the content file. Once the media files 815 are approved to be published to the network, they are transmitted to Published Content Catalog 820 and assigned a display schedule. Assignment of the display schedule 838, 848, 858 may occur before or after the media files 815 are transmitted to the Published Content Catalog 820.

Advertising Network (ADNET)

Published Content Catalog 820 stores all media files 825 that have been approved for publishing to the network, along with rules tags 826 associated with the media files 825. In order to promulgate the media files 825 throughout the network, computers 830, 840, 850 at the various locations on the network communicate with the Published Content Catalog 820. Computers 830, 840, 850 each have resident communications agents 833, 843, 853, respectively. The communications agents send a message to the Published Content Catalog 820 containing a list of media files stored on the local computer 830, 840, 850. In response to the list, the Published Content Catalog 820 determines which content files 825 are appropriate to be transmitted to each location based on the previously specified rules and guidelines. The Published Content Catalog 820 then promulgates the appropriate display schedules 838, 848, 858 prior to transmitting the media files 835, 845, 855. Once the display schedules 838, 848, 858 are stored on the local computer 830, 840, 850, the associated media files 835, 845, 855, along with rules tags 838, 848, 858, are transmitted from the Published Content Catalog 820 and stored on the local system 830, 840, 850. The media files 835, 845, 855 are then prepared to be displayed on the local advertising network in accordance with the relevant rules 836, 846, 856 and display schedule 838, 848, 858 via outputs 832, 842, 852 to the local advertising networks. The system also has the capability to generate reports related to the content files 835, 845, 855, such as number, length, frequency of displays and display cycles, etc. These reports can be automatically generated and transmitted over the integrated network in accordance with system settings and provide a valuable billing tool.

Once the media files 835, 845, 855 are promulgated and stored on the local computers 830, 840, 850 the system determines which files stored on the local computers 830, 840, 850 should be deleted. In order to perform this function, the communications agents send a message to the Published Content Catalog 820 requesting instructions on which files 835, 845, 855 should be deleted. The Published Content Catalog 820 then transmits instructions regarding which files on the local computers 830, 840, 850 that should be marked for deletion or “tombstoned”. These files are properly marked and prepared to be deleted at an appropriate time which may be based on rules, deletion cycles, manual deletion, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, “substantially,” “generally,” “significantly”, and other terms of degree are relative modifiers intended to indicate permissible variation from the characteristic so modified. They are not intended to be limited to the absolute value or characteristic which they modify but rather possessing more of the physical or functional characteristic than their opposite, and preferably, approaching or approximating such a physical or functional characteristic. It will be further understood that the terms “comprises” and/or “comprising,” as used herein, specify the presence of stated features, integers, steps, operations, elements, and/or components, but do not preclude the presence or addition of one or more other features, integers, steps, operations, elements, components, and/or groups thereof.

While the present invention and various exemplary embodiments are discussed with regard to HDTV tuner inputs, particularly live broadcast HDTV, the system and method may also utilize other HD and non-HD input sources. Input sources may include HDTV tuners, satellite TV tuners, cable TV tuners, game consoles, video players, etc. without departing from the invention. Means for processing and combining a High Definition video signal may be performed by the Customer Premises Equipment (CPE), including the Display Interface or Video Mixer.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of processing a broadcast digital television signal, comprising:
receiving a broadcast digital video signal including television content;
obtaining at least one other digital signal including digital content;
combining said broadcast digital video signal with said at least one other digital signal to form a combined digital media signal including a unitary image that maintains the integrity of said television content of said broadcast digital video signal and the entire digital content is unobstructed by said television content; and
outputting the combined digital media signal.

2. A method according to claim 1, further comprising displaying the unitary image contained in the combined digital media signal.

3. A method according to claim 1, further comprising displaying the unitary image contained in said combined digital media signal in High Definition.

4. A method according to claim 1, wherein said received broadcast digital video signal is a High Definition signal having a plurality of images and said at least one other digital signal is a non-broadcast High Definition signal having an image.

5. A method according to claim 4, further comprising:
displaying the unitary image in the combined digital media signal on one or more displays, wherein the television content is contiguous to the digital content.

6. A method according to claim 5, wherein said television content is wrapped by the digital content.

7. A method according to claim 5, wherein the digital content of said at least one other digital signal changes over time.

8. A method according to claim 4, wherein the combined digital media signal includes television content that is substantially identical to the television content of the broadcast digital video signal.

9. A method according to claim 4, wherein said at least one other digital signal comprises a video signal.

10. A method according to claim 4, wherein said at least one other digital signal comprises a non-video signal.

11. A method of converging a High Definition Television (HDTV) signal, comprising:
receiving a first main High Definition video signal including television content;
receiving at least a second main High Definition video signal including primary digital content;
obtaining at least one auxiliary High Definition signal including auxiliary digital content;
combining said first main High Definition video signal with the at least one auxiliary High Definition signal to form a first combined High Definition signal including a first unitary image having television content contiguous to auxiliary content;
combining said second main High Definition video signal with the at least one auxiliary signal to form a second combined High Definition including a second unitary image having primary digital content contiguous to auxiliary content; and
outputting said first combined High Definition signal and said second combined High Definition signal.

12. The method according to claim 11, further comprising:
displaying said first unitary image on at least a first display, wherein the television content is wrapped by the auxiliary content; and
displaying said second unitary image on at least a second display, wherein the primary digital content is wrapped by auxiliary digital content.

13. The method according to claim 12, wherein said first unitary image includes auxiliary digital content that is different from the auxiliary digital content of the second unitary image.

14. The method according to claim 12, wherein said first unitary image includes auxiliary digital content that is the same as the auxiliary digital content of the second unitary image.

15. A method according to claim 11, wherein said at least one auxiliary High Definition signal comprises a signal selected from the group consisting of a video signal and a non-video signal.

16. A computer program product comprising a computer useable medium including a computer readable program, wherein the computer readable program when executed on a computer causes the computer to:
receive a broadcast video signal, wherein said signal includes television content;
obtain at least one other digital signal, wherein said signal includes digital content; and,
combine said broadcast digital video signal and said at least one other digital signal into one combined digital media signal including a unitary image that maintains the integrity of the broadcast digital video signal.

17. The computer program product of claim 16, wherein the computer readable program further causes the computer to:
display said unitary image of said combined digital media signal on one or more monitors.

18. The complete program product of claim 17, wherein the broadcast digital video signal and the at least one other signal is a High Definition signal.

19. A data processing system comprising:
means for combining a High Definition broadcast digital video signal including television content with an auxiliary High Definition digital signal including digital content to form a unitary image wherein the television content is contiguous to the digital content; and
at least one display connected to said means for combining that displays the unitary image.

20. A method for scheduling and displaying media on an advertising network, comprising:
receiving a list of advertisement files into a content catalog wherein said list contains at least one advertisement file;
approving said advertisement files to be included in a database of advertisement files, wherein approving said advertisements files includes:
accepting the advertisement file parameters to ensure compliance with system guidelines,
reviewing the content of the advertisement file to ensure compliance with appropriateness standards, and
placing a rules tag on the advertisement file that regulates how the file is to be displayed;
authorizing the advertisement file for publication;
publishing the advertisement file to the advertising network;
assigning a display schedule to the advertisement file; and
displaying the advertisement file consistent with said display schedule and rules tags.
